(19) United States
(12) Patent Application Publication
(10) Pub. No.: US 2022/0130132 A1
(43) Pub. Date: Apr. 28, 2022

(54) IMAGE PROCESSING METHOD, IMAGE PROCESSING APPARATUS, AND PROGRAM

(71) Applicant: NEC corporation, Minato-ku, Tokyo (JP)

(72) Inventor: Chihiro HARADA, Tokyo (JP)

(73) Assignee: NEC corporation, Minato-ku, Tokyo (JP)

(21) Appl. No.: 17/437,698

(22) PCT Filed: Mar. 4, 2020
(86) PCT No.: PCT/JP2020/009055

§ 371 Date: Sep. 9, 2021

(30) Foreign Application Priority Data
Mar. 19, 2019 (JP) 2019-051168

(51) Int. Cl. G06V 10/75; G06V 10/22; G06T 7/00

(52) U.S. Cl. CPC G06V 10/758; G06T 7/001; G06V 10/235

(57) ABSTRACT

An image processing apparatus includes an evaluator that evaluates the confidence levels of categories in the evaluation area of an input image using a model for evaluating categories in a predetermined area of a predetermined image and an area setting unit that extracts the confidence level of a selection category, which is a selected category in a selection area, which is a selected area including the evaluation area of the input image and sets an area corresponding to the selection category in the input image based on the confidence level of the selection category.

### TECHNICAL FIELD

The present invention relates to an image processing method, image processing apparatus, and program.

### BACKGROUND ART

Creating a model by machine-learning a great amount of data and automatically determining various phenomena using this model has become a practice in various fields in recent years. For example, such a model is used to determine at the production side whether a product is normal or defective, based on an image of the product. As a more specific example, such a model is used to check whether a “flaw,” “dent,” “bubble crack,” or the like is present on the coated surface of the product.

On the other hand, creating an accurate model by machine learning requires causing the model to learn a great amount of teacher data. However, creating a great amount of teacher data disadvantageously requires high cost. Moreover, the quality of teacher data influences the accuracy of machine learning and therefore high-quality teacher data has to be created even if the amount of teacher data is small. Creating high-quality teacher data also disadvantageously requires high cost.

Patent document 1: Japanese Patent No. 6059486

### SUMMARY OF INVENTION

Patent Document 1 describes a technology related to facilitation of creation of teacher data used to classify a single image. However, unlike creating teacher data used to classify a single image, creating teacher data used to specify the category of the shape of a specific area in an image requires very high cost. That is, even if the shape of an object in an image is complicated, an operator who creates teacher data has to specify an accurate area, disadvantageously resulting in very high work cost. Not only creation of teacher data as described above but also image creation involving work, such as specification of a certain area in an image evaluated using a model, disadvantageously requires high work cost.

Accordingly, an object of the present invention is to solve the above disadvantage, that is, the disadvantage that image creation involving work, such as specification of an area in an image, requires high cost.

An image processing method according to an aspect of the present invention includes evaluating a confidence level of each of categories in an evaluation area of an input image using a model for evaluating categories in a predetermined area of a predetermined image, extracting a confidence level of a selection category in a selection area including the evaluation area of the input image, the selection category being a selected category, the selection area being a selected area, and setting an area corresponding to the selection category in the input image based on the confidence level of the selection category.

An image processing apparatus according to another aspect of the present invention includes an evaluator configured to evaluate a confidence level of each of categories in an evaluation area of an input image using a model for evaluating categories in a predetermined area of a predetermined image and an area setting unit configured to extract a confidence level of a selection category in a selection area including the evaluation area of the input image, the selection category being a selected category, the selection area being a selected area, and to set an area corresponding to the selection category in the input image based on the confidence level of the selection category.

A program according to yet another aspect of the present invention is a program for implementing, in an information processing apparatus, an evaluator configured to evaluate a confidence level of each of categories in an evaluation area of an input image using a model for evaluating categories in a predetermined area of a predetermined image and an area setting unit configured to extract a confidence level of a selection category in a selection area including the evaluation area of the input image, the selection category being a selected category, the selection area being a selected area, and to set an area corresponding to the selection category in the input image based on the confidence level of the selection category.

The present invention thus configured is able to suppress the cost of image creation involving work of specifying an area in an image.

### BRIEF DESCRIPTION OF THE DRAWINGS

FIG. 1 is a block diagram showing a configuration of an image processing apparatus according to a first example embodiment of the present invention;

FIG. 2 is a flowchart showing an operation of the image processing apparatus disclosed in FIG. 1;

FIG. 3 is a flowchart showing an operation of the image processing apparatus disclosed in FIG. 1;

FIG. 4 is a flowchart showing an operation of the image processing apparatus disclosed in FIG. 1;

FIG. 5 is a flowchart showing an operation of the image processing apparatus disclosed in FIG. 1;

FIG. 6 is a flowchart showing an operation of the image processing apparatus disclosed in FIG. 1;

FIG. 7 is a drawing showing the state of image processing performed by the image processing apparatus disclosed in FIG. 1;

FIG. 8 is a drawing showing the state of image processing performed by the image processing apparatus disclosed in FIG. 1;

FIG. 9 is a drawing showing the state of image processing performed by the image processing apparatus disclosed in FIG. 1;

FIG. 10 is a drawing showing the state of image processing performed by the image processing apparatus disclosed in FIG. 1;

FIG. 11 is a drawing showing the state of image processing performed by the image processing apparatus disclosed in FIG. 1;

FIG. 12 is a drawing showing the state of image processing performed by the image processing apparatus disclosed in FIG. 1;

FIG. 13 is a drawing showing the state of image processing performed by the image processing apparatus disclosed in FIG. 1;

FIG. 14 is a drawing showing the state of image processing performed by the image processing apparatus disclosed in FIG. 1;

FIG. 15 is a block diagram showing a hardware configuration of an image processing apparatus according to a second embodiment of the present invention;

FIG. 16 is a block diagram showing a configuration of the image processing apparatus according to the second embodiment of the present invention; and

FIG. 17 is a flowchart showing an operation of the image processing apparatus according to the second embodiment of the present invention.

### DESCRIPTION OF EMBODIMENTS

### First Example Embodiment

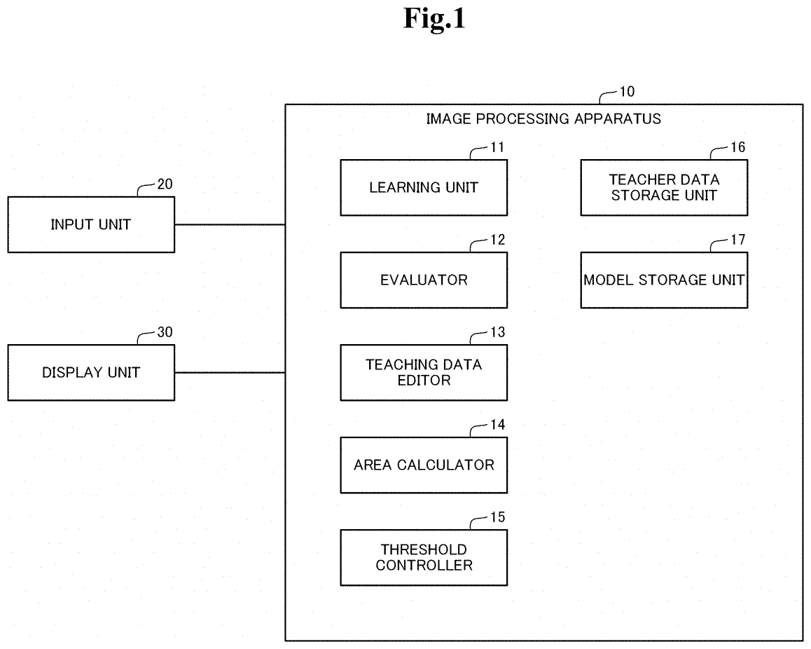

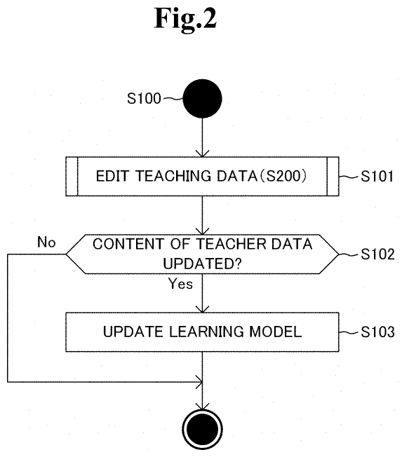

A first example embodiment of the present invention will be described with reference to FIGS. 1 to 14. FIG. 1 is a diagram showing a configuration of an image processing apparatus, and FIGS. 2 to 14 are diagrams showing image processing operations performed by of the image processing apparatus.

### [Configuration]

An image processing apparatus 10 according to the present invention is an apparatus for creating a learning model (model) that detects defective portions in an image by performing machine learning using teacher data consisting of an image, which are previously prepared learning data. The image processing apparatus 10 is also an apparatus for assisting in creating teacher data used to create such a learning model.

In the present embodiment, it is assumed that a learning model is created that when visually checking a product, detects defective portions, such as “flaws,” “dents” or “bubble cracks,” from an image of the coated surface of the product. It is also assumed that teacher data is created that includes the areas of defective portions, such as “flaws,” “dents,” or “bubble cracks,” present in the image of the coated surface of the product and categories representing the types of the defective portions.

Note that the image processing apparatus 10 need not necessarily create the above-mentioned type of learning model and may create any type of learning model. Also, the image processing apparatus 10 need not have the function of creating a learning model and may have only the function of assisting in creating teacher data. Also, the image processing apparatus 10 need not be used to assist in creating the above-mentioned type of teacher data and may be used to assist in creating any type of image.

The image processing apparatus 10 includes one or more information processing apparatuses each including an arithmetic logic unit and a storage unit. As shown in FIG. 1, the image processing apparatus 10 includes a learning unit 11, an evaluator 12, a teaching data editor 13, an area calculator 14, and a threshold controller 15 implemented by execution of a program by the arithmetic logic unit(s). The storage unit(s) of the image processing apparatus 10 includes a teacher data storage unit 16 and a model storage unit 17. An input unit 20, such as a keyboard or mouse, that receives an operation from an operator and inputs the operation to the image processing apparatus 10 and a display unit 30, such as a display, that display-outputs video signals are connected to the image processing apparatus 10. The respective elements will be described in detail below.

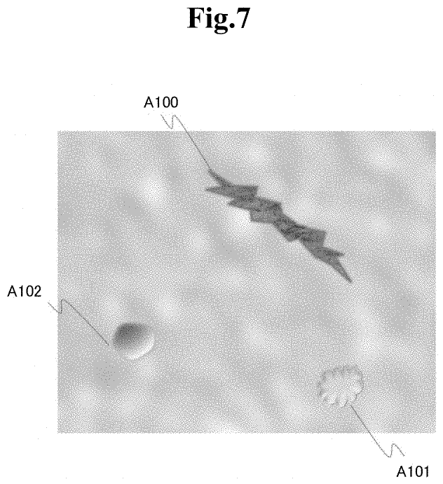

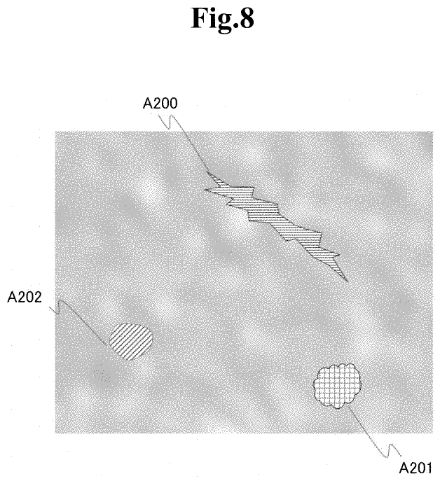

The teacher data storage unit 16 is storing teacher data, which is learning data used to create a learning model. The “teacher data” consists of information obtained by combining “teacher image” (input image) and “teaching data” prepared by the operator. For example, the “teacher image” include a photographic image of the coated surface of a product as shown in FIG. 7, and defective portions, such as a “flaw” A100, a “dent” A101, and a “bubble crack” A102, are present in this photographic image. The “teaching data” consists of information on “teaching areas” (area information) representing the areas of the defective portions, such as the “flaw” A100, “dent” A101, and “bubble crack” A102, and information on “categories” representing the types of the defective portions. For example, as shown in FIG. 8, “teaching data” corresponding to the “teacher image” shown in FIG. 7 consists of information on the “teaching areas” representing the areas of the defective portions, such as the “flaw” A100, “dent” A101, and “bubble crack” A102, and information on “categories” representing the types of the defects formed in the “teaching areas.”

The teacher data storage unit 16 is storing one or more pieces of “teacher data” previously created by the operator. Also, as will be described later, the teacher data storage unit 16 will store “teacher data” newly created later with the assistance of the image processing apparatus 10.

The learning unit 11 creates a learning model by learning the above “teacher data” stored in the teacher data storage unit 16 using a machine learning technique. In the present embodiment, the learning unit 11 uses the teacher image of the teacher data as input image and learns what category of defective portion is present in what area of the input image, in accordance with the teaching data. Thus, the learning unit 11 creates a learning model that when receiving an input image provided with no teaching data, outputs the categories and areas of defective portions present in the input image. The learning unit 11 then stores the created model in the model storage unit 17. Note that it is assumed that the learning unit 11 has previously created a learning model by learning “teacher data” prepared by the operator and stored the created learning model in the model storage unit 17.

Also, as will be described later, the learning unit 11 will update the learning model by further learning “teacher data” newly created later with the assistance of the image processing apparatus 10 and then store the updated learning model in the model storage unit 17.

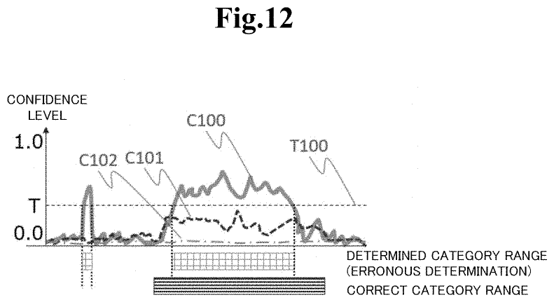

The evaluator 12 evaluates teacher data stored in the teacher data storage unit 16 using a learning model stored in the model storage unit 17. Specifically, the evaluator 12 first inputs the teacher image of teacher data selected by the operator to a learning model and predicts the categories of defective portions present in the teacher image. At this time, the evaluator 12 outputs the confidence level at which each of pixels in the teacher image is determined to be each category. For example, as shown in FIG. 12, the evaluator 12 outputs the confidence levels at which each pixel is determined to be the category “dent” C100, category “flaw” C101, and category “bubble crack” C102. Note that although the pixels in the image are actually two-dimensional, a one-dimensional confidence level graph whose lateral axis represents each pixel is shown in an example of FIG. 12 for convenience.

FIG. 12 is a graph showing the confidence level at which each pixel in an area including a defective portion “flaw” A200 in the teacher image shown in FIG. 8 evaluated as an evaluation area is determined to be each category. In the example confidence level graph of FIG. 12, the defective portion “flaw” A200 is erroneously determined to be a category “dent” C100, in which there are many pixels having confidence levels exceeding a threshold T100. In this case, the operator requests the image processing apparatus 10 to assist in editing the teacher data.

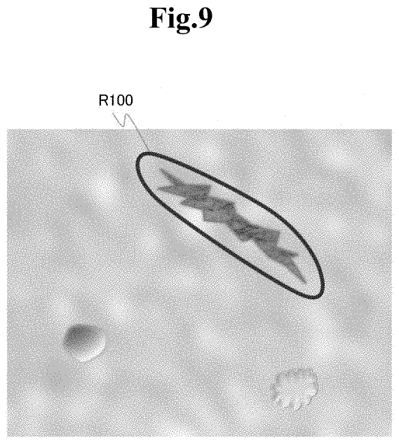

When the teaching data editor 13 (area setting unit) receives the teacher data edit assistance request from the operator, it receives selection of an area to be edited in the teacher image and selection of the category in this area from the operator. For example, the teaching data editor 13 receives, as a selection area, an area shown by reference sign R100 in the teacher image inputted by the operator using the input unit 20 as shown in FIG. 9. The teaching data editor 13 also receives, as a selection category, the category “flaw” added to the teacher data as the correct category, from the operator. As an example, the operator draws, on the teacher image shown in FIG. 7, an area surrounding the periphery of the “flaw” A100 to be edited and selects this area as an area shown by reference sign R100 in FIG. 9. While the selection area R100 may be an area that roughly surrounds the periphery of the “flaw” A100 so as to include an area desired to be set as a teaching area later, a better result is obtained as the selection area R100 is closer to the actual correct data A200 in the teacher image shown in FIG. 8.

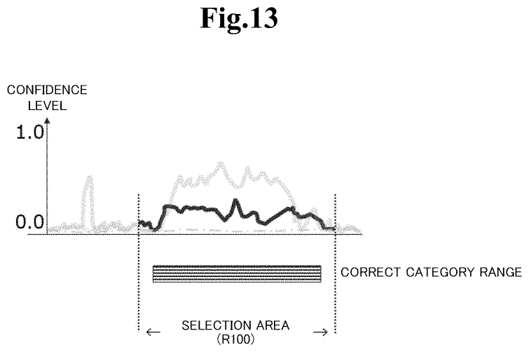

The area calculator 14 (area setting unit) extracts the selection area and the confidence level of the selection category selected by the teaching data editor 13 from the confidence level graph outputted by the evaluator 12. That is, as shown in FIG. 13, the area calculator 14 extracts a graph showing the confidence level of the category “flaw” C101 serving as the selection category of each pixel in the selection area R100 shown in FIG. 9 from the confidence level graph shown in FIG. 12. In other words, the area calculator 14 extracts a confidence level graph of the category “flaw” C101 as shown in FIG. 13 by excluding the confidence level of the category “dent” C100, the confidence level of the category “bubble crack” C102, and the confidence levels of pixels in areas other than the selection area R100 from the confidence level graph shown in FIG. 12. Note that the confidence level graph shown in FIG. 13 represents the confidence level distribution of the selected category of each pixel in the selection area. For this reason, this confidence level is used to extract the shape of the “flaw” A100 shown in FIG. 7, as will be described later.

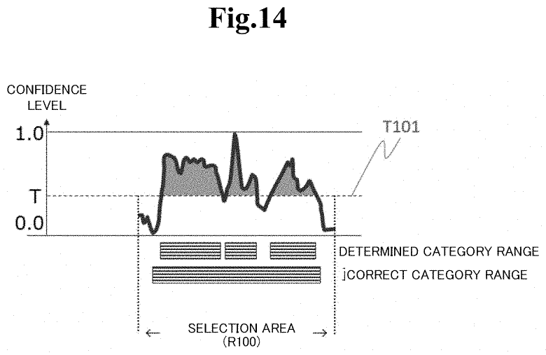

The area calculator 14 then calculates and sets an area corresponding to the category “flaw,” which is the selection category, in the teacher image based on the extracted confidence level graph of the category “flaw” C101. Specifically, as shown in FIG. 14, the area calculator 14 normalizes the extracted confidence levels of the category “flaw” to a range of 0.1 to 1.0. The area calculator 14 also sets an area in which the normalized confidence level is equal to or greater than a threshold T101, as a teaching area corresponding to the selection category. The area calculator 14 regards the newly set teaching area as “teaching data” along with the category “flaw,” which is the selection category, creates new “teacher data” by adding the teaching data to the “teacher image,” and stores the teacher data in the teacher data storage unit 16.

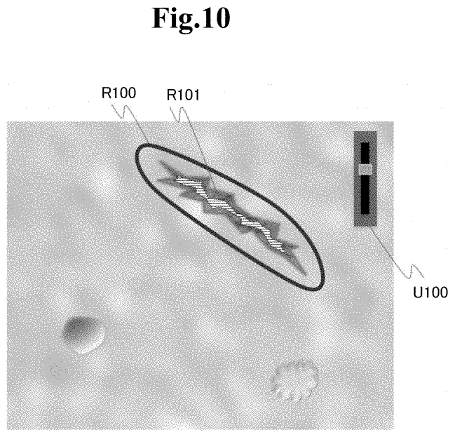

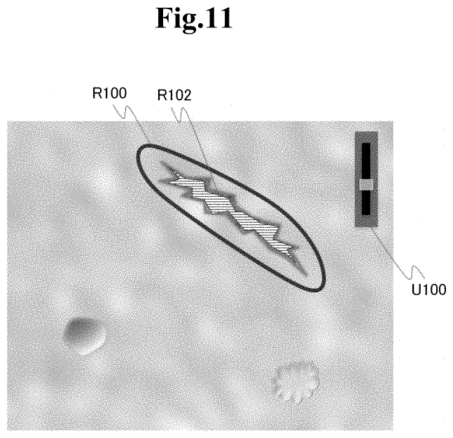

Each time the threshold value is controlled and changed by the threshold controller 15, the area calculator 14 calculates and sets a teaching area. Then, as shown in FIG. 10 or 11, the area calculator 14 (display controller) sets the calculated teaching area as R101 or R102 in the teacher image and outputs the teaching area R101 or R102 to the display screen of the display unit 30 so that a border indicating the teaching area R101 or R102 (area information) is displayed along with the teacher image.

The threshold controller 15 (threshold operation unit) provides an operation unit that when operated by the operator, changes the threshold. In the present embodiment, the threshold controller 15 provides a slider U100 displayed on the display screen along with the teacher image having the teaching areas R101 and 102 set thereon, as shown in FIG. 11. The slider U100 is provided with a vertically slidable control. The operator changes the threshold T101 shown in FIG. 14 by sliding the control. For example, the value of the threshold T101 is reduced by moving the control in a state of FIG. 10 downward as shown in FIG. 11. With the change in the threshold T101, the calculated, set, displayed teaching area is also changed from the teaching area R101 shown in FIG. 10 to the teaching area R102 shown in FIG. 11.

### [Operation]

Next, operations of the image processing apparatus 10 will be described mainly with reference to the flowcharts of FIGS. 2 to 6. Here, it is assumed that teacher data as described above is used and that a learning model created using previously prepared teacher data is already stored in the model storage unit 17.

First, referring to FIG. 2, the overall operation of the image processing apparatus 10 will be described. A process S100 shown in FIG. 2 is started at the time point when the operator starts to newly create the teaching data of a teacher image (teacher data). The image processing apparatus 10 inputs the teacher image to the learning model and edits teaching data to be added to the teacher image based on the output (step S101). If the content of the teaching data is changed (Yes in step S102), the image processing apparatus 10 newly creates teacher data in accordance with the change in the content of the teaching data and stores the newly created teacher data in the teacher data storage unit 16. The image processing apparatus 10 then updates the learning model by performing machine learning using the newly created teacher data and stores the updated learning model in the model storage unit 17 (step S103).

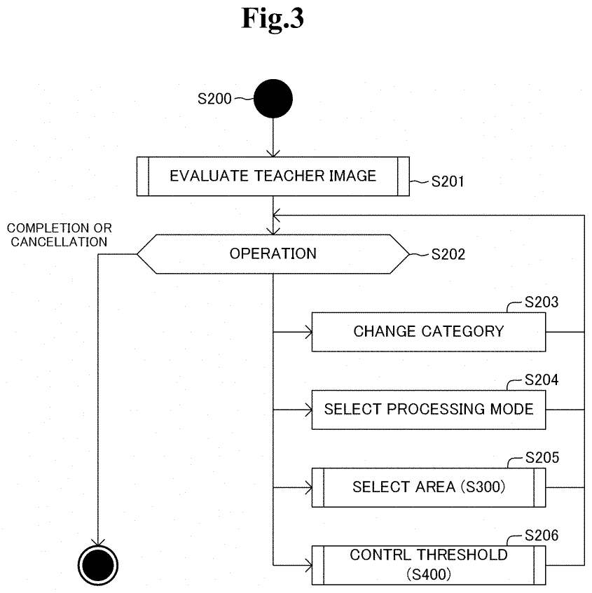

A process S200 shown in FIG. 3 is detailed description of the teaching data edit process in the above-mentioned step S101 shown in FIG. 2. When the operator starts to create teaching data, the image processing apparatus 10 evaluates the teacher image inputted using the learning model (step S201). Until the creation of teaching data is completed or canceled (step S202), the image processing apparatus 10 processes operations received from the operator in accordance with the evaluation (step S203 to S206). For example, in step S203, the image processing apparatus 10 receives selection of a category made by the operator to change the category evaluated in the teacher image. In step S204, the image processing apparatus 10 receives selection of a process desired by the operator, such as a process of receiving assistance in specifying a teaching area (referred to as the “assistance mode”) or a process of deleting a specified teaching area. In step S205, the image processing apparatus 10 processes an area drawn and selected by the operator on the teacher image (S300). In step S206, the confidence level of a category used to calculate the teaching area is controlled using a user interface (UI), such as the slider U100 shown in FIG. 10 (S400).

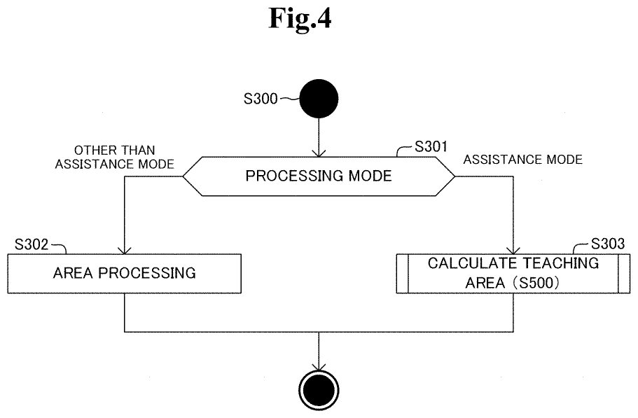

A process S300 shown in FIG. 4 is a description of the process in the above-mentioned step S205 shown in FIG. 3. If the current processing mode is a mode other than the assistance mode (“other than assistance mode” in step S301), the image processing apparatus 10 performs a process corresponding to that mode (step S302). For example, the image processing apparatus 10 performs a process of changing the selection area to the teaching area of the category currently being selected, or an edit process of clearing the teaching area specified in the selection area. If the current processing mode is the assistance mode (“assistance mode” in step S301), the image processing apparatus 10 performs a process of calculating a teaching area in the selection area (step S303 (S500)) (to be discussed later).

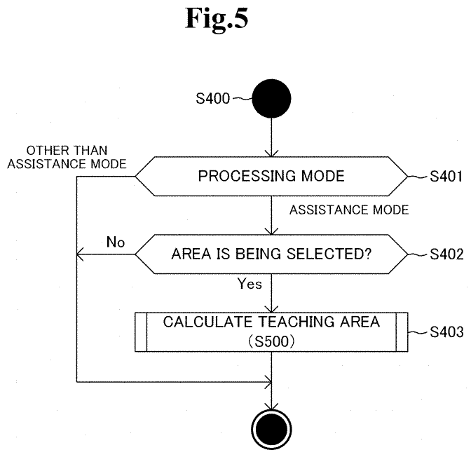

A process S400 shown in FIG. 5 is a description of the process in the above-mentioned step S303 shown in FIG. 4. The image processing apparatus 10 updates the threshold of the confidence level in response to the control of the slider U100 being operated. If the current processing mode is the assistance mode (“assistance mode” in step S401) and if the area is selected (Yes in step S402), the image processing apparatus 10 performs a process of calculating a teaching area in the selection area (S500) (to be discussed later).

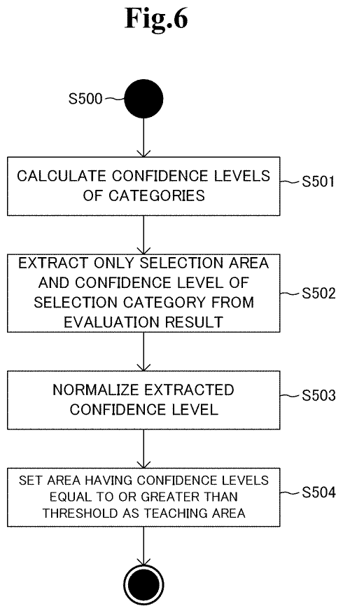

A process S500 shown in FIG. 6 is a process of calculating the teaching area of the category currently being selected in the selection area. First, the image processing apparatus 10 calculates the confidence level of the category of each of the pixels based on the evaluation of the teacher image made in the above-mentioned step S201 in FIG. 2 (step S501). The image processing apparatus 10 then handles only data on the confidence levels of categories other than the category serving as the current evaluation result among the calculated confidence levels (step S502) and normalizes the confidence levels to a range of 0.0 to 1.0 (step S503). The image processing apparatus 10 then sets an area having confidence levels equal to or greater than the threshold as a teaching area (step S504).

The processes in the above-mentioned steps S501 to S504 will be described with reference to FIGS. 7 to 14 using an example in which the operator sets the category “flaw” in the predetermined area A100 on the teacher image shown in FIG. 7.

First, in step S501, the image processing apparatus 10 evaluates the teacher image. Here, it is assumed that the confidence level graph shown in FIG. 12 has been obtained as a result of the evaluation. The confidence level graph shows that the confidence level C100 of the category “dent” has high values in a pixel range shown in a grid and therefore this area is erroneously determined to be a “dent.” Correctly, the category “flaw” C101 is a correct category in a pixel range shown in stripes.

At this time, the operator selects the category “flaw,” sets the processing mode to the assistance mode, and selects the selection area R100 surrounding the periphery of the “flaw” A100 on the teacher image shown in FIG. 9. Then, in step S502, the image processing apparatus 10 excludes the confidence level C100 of the category “dent” and the confidence level C102 of the category “bubble crack” from the confidence level graph shown in FIG. 12 based on the selection area R100 and the category “flaw” selected by the operator, as well as excludes the confidence levels of categories in areas other than the selection area R100. Thus, as shown in FIG. 13, the image processing apparatus 10 extracts only the confidence level data of the category “flaw” in the selection area R100.

As described above, the confidence levels shown in FIG. 13 represent the confidence level distribution of the category selected in the selection area. For this reason, by using these confidence levels to extract the shape of the “flaw” A100 on the teacher image, a useful result can be obtained. For this reason, in step S503, the image processing apparatus 10 normalizes the confidence levels of FIG. 13 to a range of 0.0 to 1.0 as shown in FIG. 14 so that the threshold is fixed to any area.

Then, by operating the slider U100 displayed on the display screen, the operator changes and controls the threshold so that the teaching area of the category “flaw” becomes an area having confidence levels equal to or greater than the predetermined threshold T101. Specifically, in step S504, when the operator moves the control of the slider U100, the image processing apparatus 10 changes the threshold in accordance with the position of the control. Then, as shown in FIG. 14, the image processing apparatus 10 calculates and sets the teaching area of the category “flaw” in accordance with the changed threshold value (step S504). That is, by moving the control in the state of FIG. 10 downward as shown in FIG. 11, the value of the threshold T101 is reduced and the teaching area is changed from the teaching area R101 of FIG. 10 to the teaching area R102 of FIG. 11. Then, as shown in FIGS. 10 and 11, the image processing apparatus 10 sets the calculated teaching areas R101 and R102 in the teacher image and outputs the teaching areas R101 and R102 to the display screen of the display unit 30 so that borders indicating the teaching areas R101 and R102 (area information) are displayed along with the teacher image.

As seen above, the present invention evaluates the confidence level of the category of each of the pixels in the input image, extracts only the confidence level of the selection category in the selection area from these confidence levels, and sets the area based on the extracted confidence level. Thus, the present invention is able to obtain image data in which a proper area corresponding to a certain category is set and to create teacher data used to create a model, at low cost. The present invention is also able to perform image data creation involving work of specifying an area with respect to an image, at low cost. The present invention is also able to input image data to the learning model and to modify the category and area with respect to the output result.

While the example in which the image processing apparatus according to the present invention is used to perform inspection or visual check of a product in the industrial field has been described, the image processing apparatus can also be used to identify or diagnose a symptom or case using images in the medical field, as well as to extract or divide an area in an image in meaningful units, for example, in units of objects.

### Second Example Embodiment

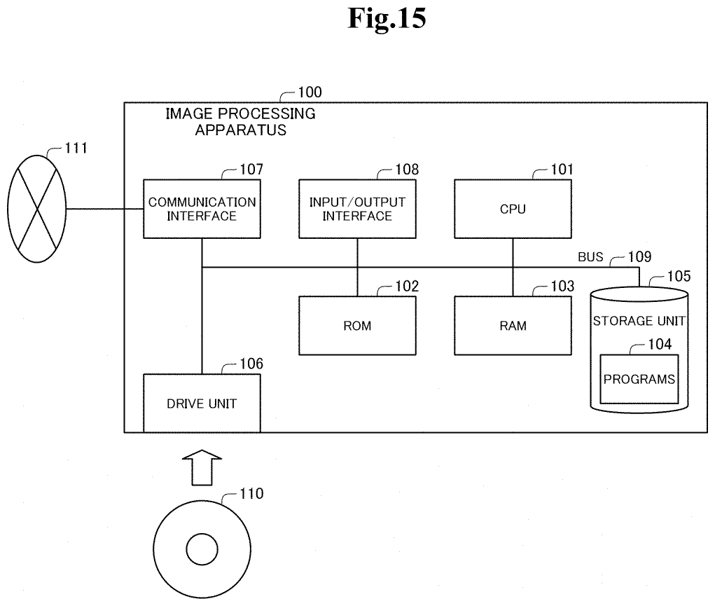

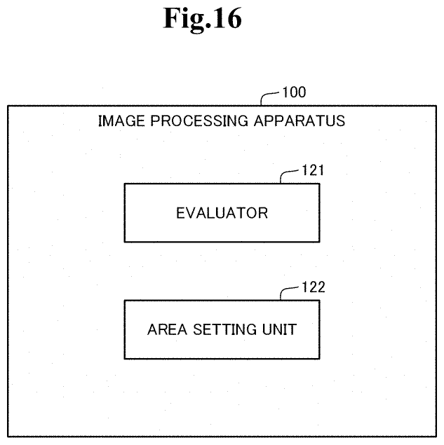

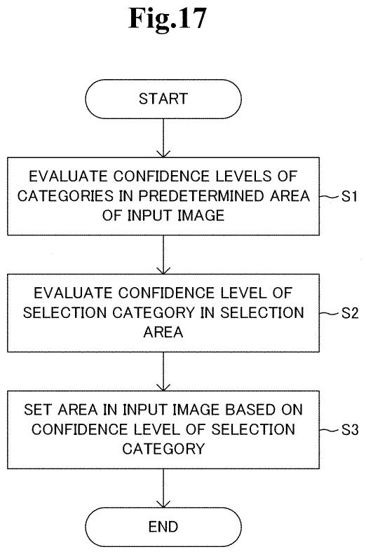

Next, a second example embodiment of the present invention will be described with reference to FIGS. 15 to 17. FIGS. 15 and 16 are block diagrams showing a configuration of an image processing apparatus according to a second example embodiment, and FIG. 17 is a flowchart showing an operation of the image processing apparatus. In the present example embodiment, the configurations of the image processing apparatus and the method performed by the image processing apparatus described in the first example embodiment are outlined.

First, a hardware configuration of an image processing apparatus 100 according to the present example embodiment will be described with reference to FIG. 15. The image processing apparatus 100 consists of a typical information processing apparatus and includes, for example, the following hardware components:
a CPU (central processing unit) 101 (arithmetic logic unit);
a ROM (read-only memory) 102 (storage unit);
a RAM (random-access memory) 103 (storage unit);
programs 104 loaded into the RAM 103;
a storage unit 105 storing the programs 104;
a drive unit 106 that writes and reads to and from a storage medium 110 outside the information processing apparatus;
a communication interface 107 that connects with a communication network 111 outside the information processing apparatus;
an input/output interface 108 through which data is outputted and inputted; and
a bus 109 through which the components are connected to each other.

When the CPU 101 acquires and executes the programs 104, an evaluator 121 and an area setting unit 122 shown in FIG. 16 are implemented in the image processing apparatus 100. For example, the programs 104 are previously stored in the storage unit 105 or ROM 102, and the CPU 101 loads and executes them into the RAM 103 when necessary. The programs 104 may be provided to the CPU 101 through the communication network 111. Also, the programs 104 may be previously stored in the storage medium 110, and the drive unit 106 may read them therefrom and provide them to the CPU 101. Note that the evaluator 121 and area setting unit 122 may be implemented by an electronic circuit.

The hardware configuration of the information processing apparatus serving as the image processing apparatus 100 shown in FIG. 15 is only illustrative and not limiting. For example, the information processing apparatus does not have to include one or some of the above components, such as the drive unit 106.

The image processing apparatus 100 performs an image processing method shown in the flowchart of FIG. 17 using the functions of the evaluator 12 and area setting unit 122 implemented based on the programs.

As shown in FIG. 11, the image processing apparatus 100:

evaluates the confidence levels of categories in the evaluation area of an input image using a model for evaluating categories in a predetermined area of a predetermined image (step S1);

evaluates the confidence level of the selection category, which is a selected category in the selection area, which is a selected area including the evaluation area of the input image (step S2); and

sets an area corresponding to the selection category in the input image based on the confidence level of the selection category (step S3).

The present invention thus configured evaluates the confidence level of the category of each of the pixels in the input image, extracts only the confidence level of the selection category in the selection area from the confidence levels, and sets the area based on the extracted confidence level. Thus, the present invention is able to obtain image data in which a proper area corresponding to a certain category is set and to create an image at low cost.

The above programs may be stored in various types of non-transitory computer-readable media and provided to a computer. The non-transitory computer-readable media include various types of tangible storage media. The non-transitory computer-readable media include, for example, a magnetic recording medium (for example, a flexible disk, a magnetic tape, a hard disk drive), a magneto-optical recording medium (for example, a magneto-optical disk), a CD-ROM (read-only memory), a CD-R, a CD-R/W, and a semiconductor memory (for example, a mask ROM, a PROM (programmable ROM), an EPROM (erasable PROM), a flash ROM, a RAM (random-access memory)). The programs may be provided to a computer by using various types of transitory computer-readable media. The transitory computer-readable media include, for example, an electric signal, an optical signal, and an electromagnetic wave. The transitory computer-readable media can provide the programs to a computer via a wired communication channel such as an electric wire or optical fiber, or via a wireless communication channel.

While the present invention has been described with reference to the example embodiments and so on, the present invention is not limited to the example embodiments described above. The configuration or details of the present invention can be changed in various manners that can be understood by one skilled in the art within the scope of the present invention.

The present invention is based upon and claims the benefit of priority from Japanese Patent Application 2019-051168 filed on Mar. 19, 2019 in Japan, the disclosure of which is incorporated herein in its entirety by reference.

### <Supplementary Notes>

Some or all of the example embodiments can be described as in Supplementary Notes below. While the configurations of the image processing method, image processing apparatus, and program according to the present invention are outlined below, the present invention is not limited thereto.

### (Supplementary Note 1)

An image processing method comprising:

evaluating a confidence level of each of categories in an evaluation area of an input image using a model for evaluating categories in a predetermined area of a predetermined image;

extracting a confidence level of a selection category in a selection area including the evaluation area of the input image, the selection category being a selected category, the selection area being a selected area; and

setting an area corresponding to the selection category in the input image based on the confidence level of the selection category.

### (Supplementary Note 2)

The image processing method of Supplementary Note 1, wherein

the evaluating the confidence levels comprises evaluating a confidence level of each of categories of each of pixels in the evaluation area of the input image using the model,

the extracting the confidence level comprises extracting the confidence level of the selection category in the selection area of the input image for each of pixels in the selection area, and

the setting the area comprises setting the area in the input image based on the confidence level of the selection category of each of the pixels in the selection area.

### (Supplementary Note 3)

The image processing method of Supplementary Note 2, wherein pixel having confidence level of the selection category equal to or greater than a threshold among the pixels in the selection area are set as the area in the input image.

### (Supplementary Note 4)

The image processing method of Supplementary Note 3, wherein

the threshold is changed in accordance with an operation from outside, and

a pixels having confidence level of the selection category of equal to or greater than the changed threshold among he pixels in the selection area is set as the area in the input image.

### (Supplementary Note 5)

The image processing method of Supplementary Note 3 or 4, further comprising display-outputting area information indicating the area set in the input image to a display screen along with an input screen.

### (Supplementary Note 6)

The image processing method of Supplementary Note 5, further comprising display-outputting, to the display screen, an operation device operable to change the threshold, wherein

a pixel having confidence levels of the selection category equal to or greater than the threshold changed by operating the operation device among the pixels in the selection area is set as the area in the input image and the area information indicating the area is display-outputted to the display screen along with the input screen.

### (Supplementary Note 7)

The image processing method of any one of Supplementary Notes 1 to 6, further comprising updating the model by inputting the input image, area information indicating the area set in the input image, and the selection category corresponding to the area to the model as teacher data and performing machine learning.

### (Supplementary Note 8)

An image processing apparatus of Supplementary Note 8:

an evaluator configured to evaluate a confidence level of each of categories in an evaluation area of an input image using a model for evaluating categories in a predetermined area of a predetermined image; and

an area setting unit configured to extract a confidence level of a selection category in a selection area including the evaluation area of the input image, the selection category being a selected category, the selection area being a selected area, and to set an area corresponding to the selection category in the input image based on the confidence level of the selection category.

### (Supplementary Note 8.1)

The image processing apparatus of Supplementary Note 8, wherein

the evaluator evaluates a confidence level of each of categories of each of pixels in the evaluation area of the input image using the model, and

the area setting unit extracts the confidence level of the selection category in the selection area of the input image for each of pixels in the selection area and sets the area in the input image based on the confidence level of the selection category of each of the pixels in the selection area.

### (Supplementary Note 8.2)

The image processing apparatus of Supplementary Note 8.1, wherein the area setting unit sets, as the area in the input image, a pixel having confidence levels of the selection category equal to or greater than a threshold among the pixels in the selection area.

### (Supplementary Note 8.3)

The image processing apparatus of Supplementary Note 8.2, further comprising a threshold operation unit configured to change the threshold in accordance with an operation from outside, wherein the area setting unit sets, as the area in the input image, a pixel having confidence levels of the selection category equal to or greater than the changed threshold among the pixels in the selection area.

### (Supplementary Note 8.4)

The image processing apparatus of Supplementary Note 8.2 or 8.3, further comprising a display controller configured to display-output, to a display screen, area information indicating the area set in the input image along with an input screen.

### (Supplementary Note 8.5)

The image processing apparatus of Supplementary Note 8.4, further comprising a threshold operation unit configured to display-output, to the display screen, an operation device operable to change the threshold, wherein

the area setting unit sets, as the area in the input image, a pixel having confidence levels of the selection category equal to or greater than the threshold changed by operating the operation device among the pixels in the selection area, and

the display controller display-outputs, to the display screen, the area information indicating the area set in the input image along with the input screen.

### (Supplementary Note 8.6)

The image processing apparatus of any one of Supplementary Notes 8 to 8.6, further comprising a learning unit configured to update the model by inputting the input image, area information indicating the area set in the input image, and the selection category corresponding to the area to the model as teacher data and performing machine learning.

### (Supplementary Note 9)

A non-transitory computer-readable storage medium storing a program for implementing, in an information processing apparatus:

an evaluator configured to evaluate a confidence level of each of categories in an evaluation area of an input image using a model for evaluating categories in a predetermined area of a predetermined image; and

an area setting unit configured to extract a confidence level of a selection category in a selection area including the evaluation area of the input image, the selection category being a selected category, the selection area being a selected area, and to set an area corresponding to the selection category in the input image based on the confidence level of the selection category.

### DESCRIPTION OF REFERENCE SIGNS

10 image processing apparatus
11 learning unit
12 evaluation unit
13 teaching data editor
14 area calculator
15 threshold controller
16 teacher data storage unit
17 model storage unit
100 image processing apparatus
101 CPU
102 ROM
103 RAM
104 programs
105 storage unit
106 drive unit
107 communication interface
108 input/output interface
109 bus
110 storage medium
111 communication network
121 evaluator
122 area setting unit

What is claimed is:

1. An image processing method comprising:
evaluating a confidence level of each of categories in an evaluation area of an input image using a model for evaluating categories in a predetermined area of a predetermined image;
extracting a confidence level of a selection category in a selection area including the evaluation area of the input image, the selection category being a selected category, the selection area being a selected area; and
setting an area corresponding to the selection category in the input image based on the confidence level of the selection category.

2. The image processing method of claim 1, wherein
the evaluating the confidence levels comprises evaluating a confidence level of each of categories of each of pixels in the evaluation area of the input image using the model,
the extracting the confidence level comprises extracting the confidence level of the selection category in the selection area of the input image for each of pixels in the selection area, and
the setting the area comprises setting the area in the input image based on the confidence level of the selection category of each of the pixels in the selection area.

3. The image processing method of claim 2, wherein a pixel having a confidence level of the selection category equal to or greater than a threshold among the pixels in the selection area is set as the area in the input image.

4. The image processing method of claim 3, wherein the threshold is changed in accordance with an operation from outside, and
a pixel having a confidence level of the selection category equal to or greater than the changed threshold among the pixels in the selection area is set as the area in the input image.

5. The image processing method of claim 3, further comprising display-outputting area information indicating the area set in the input image to a display screen along with an input screen.

6. The image processing method of claim 5, further comprising display-outputting, to the display screen, an operation device operable to change the threshold, wherein
a pixel having a confidence level of the selection category equal to or greater than the threshold changed by operating the operation device among the pixels in the selection area are is as the area in the input image and the area information indicating the area is display-outputted to the display screen along with the input screen.

7. The image processing method of claim 1, further comprising updating the model by inputting the input image, area information indicating the area set in the input image, and the selection category corresponding to the area to the model as teacher data and performing machine learning.

8. An image processing apparatus comprising:
a memory storing instructions; and
at least one processor configured to execute the instructions, the instructions comprising:
evaluating a confidence level of each of categories in an evaluation area of an input image using a model for evaluating categories in a predetermined area of a predetermined image; and
extracting a confidence level of a selection category in a selection area including the evaluation area of the input image, the selection category being a selected category, the selection area being a selected area, and setting an area corresponding to the selection category in the input image based on the confidence level of the selection category.

9. The image processing apparatus of claim 8, wherein the instructions comprise:
evaluating a confidence level of each of categories of each of pixels in the evaluation area of the input image using the model; and
extracting the confidence level of the selection category in the selection area of the input image for each of pixels in the selection area and sets the area in the input image based on the confidence level of the selection category of each of the pixels in the selection area.

10. The image processing apparatus of claim 9, wherein the instructions comprise setting, as the area in the input image, a pixel having a confidence level of the selection category equal to or greater than a threshold among the pixels in the selection area.

11. The image processing apparatus of claim 10, wherein the instructions comprise:
changing, the threshold in accordance with an operation from outside; and
setting, as the area in the input image, a pixel having a confidence level of the selection category equal to or greater than the changed threshold among the pixels in the selection area.

12. The image processing apparatus of claim 10, wherein the instructions comprise display-outputting, to a display screen, area information indicating the area set in the input image along with an input screen.

13. The image processing apparatus of claim 12, wherein the instructions comprise:
display-outputting, to the display screen, an operation device operable to change the threshold;
setting, as the area in the input image, a pixel having a confidence level of the selection category equal to or greater than the threshold changed by operating the operation device among the pixels in the selection area and
outputting, to the display screen, the area information indicating the area set in the input image along with the input screen.

14. The image processing apparatus of claim 8, wherein the instructions comprise updating the model by inputting the input image, area information indicating the area set in the input image, and the selection category corresponding to the area to the model as teacher data and performing machine learning.

15. A non-transitory computer-readable storage medium storing a program for causing an information processing apparatus to perform:
a process of evaluating a confidence level of each of categories in an evaluation area of an input image using a model for evaluating categories in a predetermined area of a predetermined image; and
a process of extracting a confidence level of a selection category in a selection area including the evaluation area of the input image, the selection category being a selected category, the selection area being a selected area and setting an area corresponding to the selection category in the input image based on the confidence level of the selection category.
